(19) United States
(12) Patent Application Publication
(10) Pub. No.: US 2023/0361591 A1
(43) Pub. Date: Nov. 9, 2023

(54) BATTERY SYSTEM WITH MULTIPLE DIFFERENT TYPES OF CELLS FOR FAST CHARGE AND LONG LIFE

(71) Applicant: GM GLOBAL TECHNOLOGY OPERATIONS LLC, Detroit, MI (US)

(72) Inventors: Srikanth ARISETTY, Novi, MI (US); Venkata Prasad ATLURI, Novi, MI (US); Charles W. WAMPLER, II, Birmingham, MI (US); Chandra S. NAMUDURI, Troy, MI (US); Raghunathan K, Troy, MI (US)

(21) Appl. No.: 17/739,341

(22) Filed: May 9, 2022

(51) Int. Cl. H02J 7/00; H01M 10/42; H01M 4/38; H01M 4/505; H01M 4/583; H01M 4/525; H01M 10/44

(52) U.S. Cl. CPC H02J 7/00712; H02J 7/0013; H02J 7/0048; H01M 10/425; H01M 4/386; H01M 4/505; H01M 4/583; H01M 4/525; H01M 10/441; H01M 2010/4271

(57) ABSTRACT

A battery pack includes: first battery modules, the first battery modules each including first battery cells having a first battery cell chemistry and not including second battery cells having a second battery cell chemistry that is different than the first battery cell chemistry; second battery modules, the second battery modules each including the second battery cells having the second battery cell chemistry and not including the first battery cells having the first battery chemistry; switches; and a switch control module configured to actuate the switches and control charging and discharging of the first and second battery modules.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to batteries and more particularly to batteries with multiple different types of battery cells.

Some types of vehicles include only an internal combustion engine that generates propulsion torque. Electric vehicles may not include an internal combustion engine and may rely on one or more electric motors for propulsion.

Hybrid vehicles include both an internal combustion engine and one or more electric motors. Some types of hybrid vehicles utilize the electric motor and the internal combustion engine in an effort to achieve greater fuel efficiency than if only the internal combustion engine was used. Some types of hybrid vehicles utilize the electric motor and the internal combustion engine to achieve greater torque output than the internal combustion could achieve by itself.

Some example types of hybrid vehicles include parallel hybrid vehicles, series hybrid vehicles, and other types of hybrid vehicles. In a parallel hybrid vehicle, the electric motor works in parallel with the engine to combine power and range advantages of the engine with efficiency and regenerative braking advantages of electric motors. In a series hybrid vehicle, the engine drives a generator to produce electricity for the electric motor, and the electric motor drives a transmission. This allows the electric motor to assume some of the power responsibilities of the engine, which may permit the use of a smaller and possibly more efficient engine.

### SUMMARY

In a feature, a battery pack includes: first battery modules, the first battery modules each including first battery cells having a first battery cell chemistry and not including second battery cells having a second battery cell chemistry that is different than the first battery cell chemistry; second battery modules, the second battery modules each including the second battery cells having the second battery cell chemistry and not including the first battery cells having the first battery chemistry; switches; and a switch control module configured to actuate the switches and control charging and discharging of the first and second battery modules.

In further features, the switches include: first bypass switches configured to selectively connect and disconnect first inputs of the first battery modules with first outputs of the first battery modules, respectively; and second bypass switches configured to selectively connect and disconnect second inputs of the second battery modules with second outputs of the second battery modules, respectively.

In further features, the first battery cell chemistry includes anodes including silicon and cathodes including nickel cobalt manganese aluminum (NMCA).

In further features, the anodes include at least 30 percent silicon.

In further features, the second battery cell chemistry includes anodes including graphite and cathodes including NMCA.

In further features, a percentage of a total number of the first and second battery cells of the battery pack that have the first battery cell chemistry is at least 20 percent and less than or equal to 80 percent.

In further features, the battery pack includes x percentage of the first battery cells and (1−x) percent of the second battery cells, wherein x is selected based on at least one of cycling lifetime, charging rate, discharging rate, and energy density.

In further features, the switch control module actuates ones of the switches to limit a depth of discharge of the first battery modules to a predetermined minimum state of charge.

In further features, the switch control module actuates other ones of the switches to discharge ones of the second battery modules to less than the predetermined minimum state of charge that is greater than zero state of charge.

In further features, the switch control module actuates ones of the switches to discharge the first battery modules at a first rate and discharge the second battery modules at a second rate that is greater than the first rate.

In a feature, a battery pack includes: battery modules each including a plurality of battery cells; where at least one of the battery modules includes first battery cells having a first battery cell chemistry and second battery cells having a second battery cell chemistry that is different than the first battery cell chemistry; switches; and a switch control module configured to actuate the switches and control charging and discharging of the battery modules and the battery cells.

In further features, the switches include: first bypass switches configured to selectively connect and disconnect first inputs of the battery modules with outputs of the battery modules, respectively.

In further features, the first battery cell chemistry includes anodes including silicon and cathodes including nickel cobalt manganese aluminum (NMCA).

In further features, the anodes include at least 30 percent silicon.

In further features, the second battery cell chemistry includes anodes including graphite and cathodes including NMCA.

In further features, a percentage of a total number of the first and second battery cells of the battery pack that have the first battery cell chemistry is at least 20 percent and less than or equal to 80 percent.

In further features, the battery cells include x percentage of the first battery cells and (1−x) percent of the second battery cells, wherein x is selected based on at least one of cycling lifetime, charging rate, discharging rate, and energy density.

In further features, the switch control module actuates ones of the switches to limit a depth of discharge of the first battery cells to a predetermined minimum state of charge that is greater than zero state of charge.

In further features, the switch control module actuates other ones of the switches to discharge ones of the second battery cells to less than the predetermined minimum state of charge.

In further features, the switch control module actuates ones of the switches to discharge the first battery cells at a first rate and discharge the second battery cells at a second rate that is greater than the first rate.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle system;

FIG. 2 is a functional block diagram of an example implementation of a battery system;

FIG. 3 is an example illustration of a battery module including both battery cells having a first battery cell chemistry and battery cells having a second battery cell chemistry; and

FIG. 4 includes an example graph of battery cell state of charge for different battery cell chemistries over time.

In the drawings, reference numbers may be reused to identify similar and/or identical elements.

### DETAILED DESCRIPTION

A battery pack of a vehicle may have, for example, graphite/nickel cobalt, manganese, aluminum (Gr/NCMA) battery cells, silicon/nickel cobalt, manganese, aluminum (Si/NCMA) battery cells, or battery cells having another suitable chemistry. Different battery cell chemistries, however, have different energy densities, cycling lifetimes, charging and discharging rates, and other characteristics.

The present application involves a battery pack having battery modules including two or more different battery cell chemistries and/or one or more battery modules including two or more different battery cell chemistries. The proportion of each type of battery cell chemistry may be set, for example, to maximize charging and discharging rate, maximize energy density, maximize cycling lifetime, and maximize one or more other characteristics of the battery pack. Charging and discharging of the different battery cell chemistries is also controlled based on the battery cell chemistry and characteristics of those battery cells.

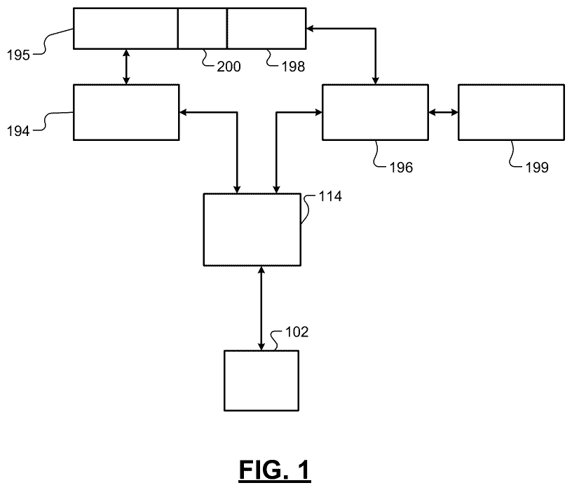

Referring now to FIG. 1, a functional block diagram of an example vehicle system is presented. While a vehicle system for a hybrid vehicle is shown and will be described, the present disclosure is also applicable to electric vehicles that do not include an internal combustion engine (including pure electric vehicles), fuel cell vehicles, autonomous vehicles, semi-autonomous vehicles, non-autonomous vehicles, and other types of vehicles. Also, while the example of a vehicle is provided, the present application is also applicable to non-vehicle implementations.

An engine 102 may combust an air/fuel mixture to generate drive torque. An engine control module (ECM) 114 controls the engine 102. For example, the ECM 114 may control actuation of engine actuators, such as a throttle valve, one or more spark plugs, one or more fuel injectors, valve actuators, camshaft phasers, an exhaust gas recirculation (EGR) valve, one or more boost devices, and other suitable engine actuators. In some types of vehicles (e.g., electric vehicles), the engine 102 may be omitted.

The engine 102 may output torque to a transmission 195. A transmission control module (TCM) 194 controls operation of the transmission 195. For example, the TCM 194 may control gear selection within the transmission 195 and one or more torque transfer devices (e.g., a torque converter, one or more clutches, etc.).

The vehicle system includes one or more electric motors, such as electric motor 198. An electric motor (also referred to as an electric machine) can act as either a generator or as a motor at a given time. When acting as a generator, an electric motor converts mechanical energy into electrical energy. The electrical energy can be, for example, used to charge a battery 199 (or battery pack). When acting as a motor, an electric motor generates torque that may be used, for example, for vehicle propulsion. While the example of one electric motor is provided, the vehicle may include more than one electric motor.

A motor control module 196 controls power flow from the battery 199 to the electric motor 198 and from the electric motor 198 to the battery 199. The motor control module 196 applies electrical power from the battery 199 to the electric motor 198 to cause the electric motor 198 to output positive torque, such as for vehicle propulsion. The battery 199 may include, for example, one or more batteries and/or battery packs.

The electric motor 198 may output torque, for example, to an input shaft of the transmission 195 or to an output shaft of the transmission 195. A clutch 200 may be engaged to couple the electric motor 198 to the transmission 195 and disengaged to decouple the electric motor 198 from the transmission 195. One or more gearing devices may be implemented between an output of the clutch 200 and an input of the transmission 195 to provide a predetermined ratio between rotation of the electric motor 198 and rotation of the input of the transmission 195.

The motor control module 196 may also selectively convert mechanical energy of the vehicle into electrical energy. More specifically, the electric motor 198 generates and outputs power via back EMF when the electric motor 198 is being driven by the transmission 195 and the motor control module 196 is not applying power to the electric motor 198 from the battery 199. The motor control module 196 may charge the battery 199 via the power output by the electric motor 198.

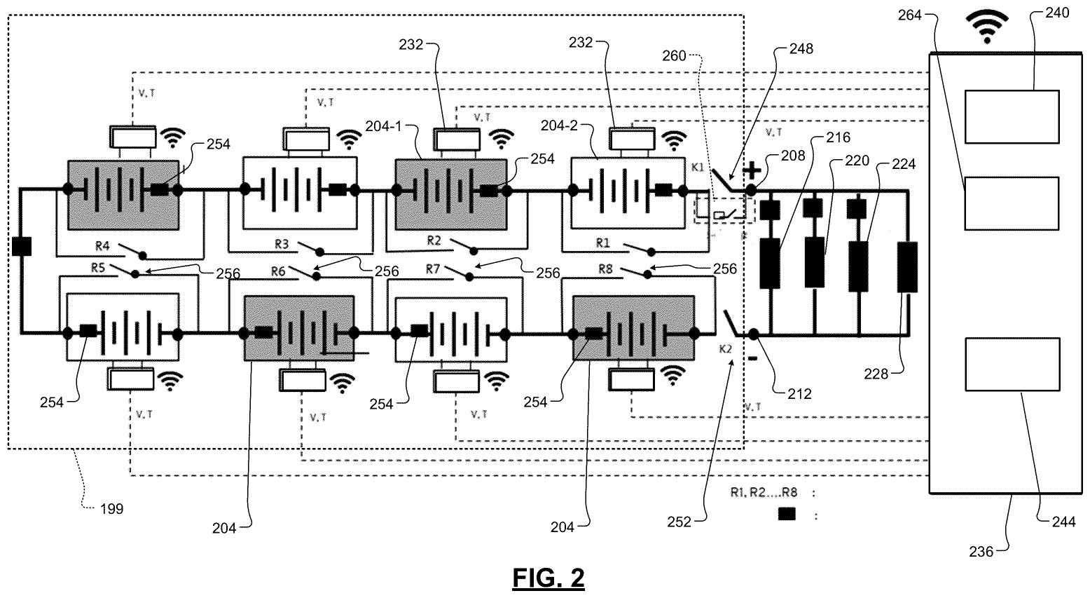

FIG. 2 is a functional block diagram of an example implementation of a battery system. The battery 199 includes a plurality of battery modules, such as 204-1, 204-2, etc., collectively referred to as battery modules 204. Each of the battery modules 204 includes a plurality of battery cells, such as pouch type battery cells, prismatic type battery cells, or a combination of pouch type and prismatic type battery cells.

Each of the battery modules 204 may have battery cells having the same (only one) chemistry. For example, some of the battery modules 204 may have only Gr/NCMA battery cells, and other ones of the battery modules 204 may have only Si/NCMA battery cells. While the examples of Gr/NCMA and Si/NCMA battery cells are provided, the present application is also applicable to other battery cell chemistries. Any cathode chemistry can be used. Anodes may be a combination of Gr and Si based or including chemistries.

Gr/NCMA battery cells include graphite (e.g., 100 percent) anodes and NCMA cathodes. Si/NCMA battery cells have anodes that include at least a predetermined percentage (e.g., 30 percent) silicon and NCMA cathodes. In the example of FIG. 2, ones of the battery modules 204 including only a first battery cell chemistry (e.g., Si/NCMA) are illustrated as shaded (e.g., 204-1), while other ones of the battery modules 204 including only a second battery cell chemistry (e.g., Gr/NCMA) are illustrated non-shaded (e.g., 204-2).

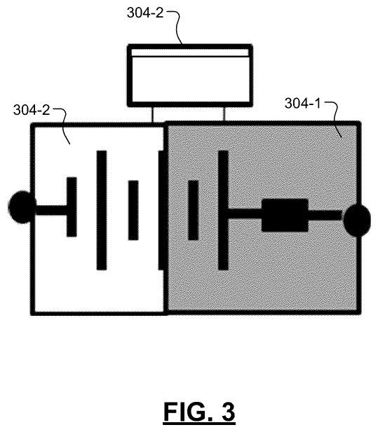

As shown in FIG. 3, in various implementations, one, more than one, or all of the battery modules 204 may include both of the first and second battery cell chemistries. In FIG. 3, battery cells having the first battery cell chemistry (e.g., Si/NCMA) are illustrated as shaded (e.g., 304-1), while battery cells having the second battery cell chemistry (e.g., Gr/NCMA) are illustrated non-shaded (e.g., 304-2).

Gr/NCMA battery cells have a lower energy density than Si/NCMA battery cells but have a longer cycling lifetime than Si/NCMA battery cells. Conversely, Si/NCMA battery cells have a higher energy density than Gr/NCMA battery cells but have a shorter cycling lifetime than Gr/NCMA battery cells at the same state of charge discharge depth. Cycling lifetime of Si/NCMA battery cells, however, can be increased if Si/NCMA battery cells are stopped from discharging below a predetermined a minimum SOC (e.g., 40% SOC) that is greater than a predetermined minimum SOC for discharging Gr/NCMA battery cells. Si/NCMA battery cells may also have a lower cost when the cell design does not involve prelithitation. Si/NMCA battery cells may have better fast charge capabilities than Gr/NCMA battery cells.

The battery modules 204 are electrically connected in series. The battery 199 is connected between a high side (+) 208 and a low side (−) 212. One or more inverters may be connected between the high and low sides 208 and 212. In the example of FIG. 2, a first inverter 216 and a second inverter 220 are connected between the high and low sides 208 and 212. The first inverter 216 may drive a first electric motor configured to transfer torque to a first one or more wheels (e.g., front wheels), and the second inverter 220 may drive a second electric motor configured to output torque to a second one or more wheels (e.g., rear wheels).

One or more other devices may also be connected between the high and low sides 208 and 212. For example, one or more direct current (DC) to DC converters 224 and one or more loads (e.g., vehicle accessories) 228 may be connected between the high and low sides 208 and 212. The DC to DC converter 224 is configured to convert a voltage between the high and low sides 208 and 212 into a second voltage that is, for example, higher or lower than the voltage between the high and low sides 208 and 212.

Each of the battery modules 204 includes a cell management module (CMM) 232, which may also be referred to as a cell management unit (CMU). Each of the battery modules 204 also includes one or more voltage sensors that measure a voltage of the battery module and one or more temperature sensors that measure a temperature of the battery module. For example, a voltage sensor may be provided for each battery cell and measure the voltage of that battery cell. A voltage sensor may also be provided and measure a voltage of the battery module. A temperature sensor may be provided for each battery cell and measure the voltage of that battery cell. Alternatively, one temperature sensor may be provided for each battery module.

The CMM 232 of each battery module transmits the voltage(s) and temperature(s) of that battery module to a battery management module (BMM) 236, which may be referred to as a battery management system (BMS). The CMMs 232 may transmit the measurements to the BMM 236 wirelessly or by wire. The BMM 236 includes a first state of charge (SOC) module 240 that determines a state of charge of the battery cells or battery modules having the first battery cell chemistry based on the measurements of the battery cells or battery modules having the first battery cell chemistry. The BMM 236 includes a second SOC module 244 that determines a state of charge of the battery cells or battery modules having the second battery cell chemistry based on the measurements of the battery cells or battery modules having the second battery cell chemistry.

First and second switches 248 and 252 (K1, K2) connect and disconnect the battery 199 to and from the high and low sides 208 and 212, respectively. Each of the battery modules 204 includes a module switch 254 that connects and disconnects the battery cells of that battery module to and from an input to that battery module. In various implementations, the module switches 254 may be solid state switches or another suitable type of switch.

The battery 199 also includes bypass relays (R1, R2, R3, R4, R5, R6, R7, R8) 256. One bypass relay is provided for each battery module. The bypass relay 256 of each battery module is configured to connect and disconnect the input to that battery module with the output of that battery module. The bypass relay 256 of a battery module may be closed when the module switch 254 of that battery module is open as to bypass that battery module. While relays are discussed, the present application is also applicable to other types of switches.

The battery 199 may also include a precharge circuit 260 that is connected between the high side 208 and the battery 199. The precharge circuit 260 includes a switch and one or more precharge capacitors. The switch of the precharge circuit 260 may be closed, for example, when the switch 252 is closed and before the switch 248 is closed to prevent a large inrush current to the battery 199 before the closing of the switch 248.

The BMM 236 also includes a switch control module 264 that controls switching of the switches 248, 252, 254, and 256. The switch control module 264 controls the switching of the switches 254 based on coordinating charging and discharging the battery cell chemistries independently, such as based on charging type (fast charging, normal charging, etc.) and based on discharging, such as for vehicle propulsion, the loads 228, etc. The switch control module 264 arbitrates between the first and second battery cell chemistries to enable at least two different charging speeds of the battery 199, such as a first charging rate (e.g., fast charging) and a second charging rate that is slower (less) than the first charging rate.

The amounts of each of the first and second battery cell chemistries may be set as follows. For example, x and (1−x) may refer to percentages of the total capacity of the battery 199 attributable to Si/NCMA and Gr/NCMA battery cells, respectively. x may be at least 20 percent and less than or equal to 80 percent. x may be set based on the battery 199 having a predetermined capacity and meet one or more other predetermined criteria. The switch control module 264 may control the switches to limit a depth of discharge of Gr/NMCA battery cells to a predetermined capacity, such as 20 percent or another suitable percentage. This may increase a cycling lifetime of the Gr/NMCA battery cells. When the SOC of the Gr/NMCA battery cells reaches the predetermined capacity, the switch control module 264 may open one or more of the switches and disconnect the Gr/NMCA battery cells or the battery modules including Gr/NMCA battery cells to prevent further discharging. Once the SOC of the Si/NMCA battery cells or battery modules including Si/NMCA battery cells reaches the predetermined capacity, the switch control module 264 may later close one or more of the switches and connect one or more of the Gr/NMCA battery cells or the battery modules including Gr/NMCA battery cells to continue discharging with the Si/NMCA battery cells.

The switch control module 264 also controls switching of the switches to discharge Si/NMCA battery cells or battery modules including only Si/NMCA battery cells at a slower rate than Gr/NMCA battery cells or battery modules including only Gr/NMCA battery cells. This may limit a capacity fade of the Si/NMCA battery cells. During fast charging of the battery, the switch control module 264 may actuate the switches to charge the Si/NMCA battery cells or battery modules including only Si/NMCA battery cells at a faster rate than Gr/NMCA battery cells or battery modules including only Gr/NMCA battery cells. This may be because Si/NCMA battery cells may be able to be charged faster than Gr/NMCA battery cells. The relationships between energy density, Discharge rate, Depth of SOC, and fast charging may be described in the following table using the proportions x and x−1 above.

| | Type 1: Si/NMC | Type 2: Gr/NMC | Total Pack |
|---|---|---|---|
| Energy | xE1 | (1-x)E2 | xE1 + (1-x)E2 |
| density | | | |
| Discharge rate | C/n: slower | C/(n-z): faster | xC/n + (1-x)C/(n-z) |
| Depth of SOC | cell soc1 | cell soc2 | x SOC1 + (1-x) |
| | <20-60% | <0-100% | soc2 |
| DCFC | nC: faster | (n-z)C: slower | xnC + (1-x)(n-z)C |

The following table may describe how the switch control module 264 may switch the switches 256 to achieve different charging speeds of the battery 199. In the table below, 0 indicates that a switch is open, and 1 indicates that a switch is closed.

| Charging mode | Si/NMC | Gr/NMC |
|---|---|---|
| Mode 1: fast charge Si/NCMA | R3, R1, R5, R7 = 0 | R2, R4, R6, R8 = 0 |
| and Gr/NCMA | | |
| Mode 2: fast charge Si/NCMA | R3, R1, R5, R7 = 0 | R2, R4, R6, R8 = 1 |
| Mode 3: Slow charge Si/NCMA | R3, R1, R5, R7 = 0 | R2, R4, R6, R8 = 0 |
| and Gr/NCMA | | |
| Mode 4: Slowest charge | R3, R1, R5, R7 = 1 | R2, R4, R6, R8 = 0 |
| Gr/NCMA | | |

As illustrated by the table above, to achieve fast charging of both Si/NMCA and Gr/NMCA cells such as with a battery charger having a first higher output voltage, the switch control module 264 may open all of the switches 256 and close all of the switches 254. To achieve fast charging of the Si/NMCA battery cells (and not the Gr/NMCA battery cells) such as with the battery charger having the first higher output voltage, the switches control modules 264 may close the ones of the switches 256 that bypass the battery modules that include Gr/NMCA battery cells, open the switches 254 of the battery modules that include Gr/NMCA battery cells, open the ones of the switches 256 that bypass the battery modules that include Si/NMCA battery cells, close the switches 254 of the battery modules that include Si/NMCA battery cells. For slower charging of both Si/NMCA and Gr/NMCA cells (e.g., with a battery charger having a second lower output voltage), the switch control module 264 may open all of the switches 256 and close all of the switches 254. To achieve slower charging of the Si/NMCA battery cells (and not the Gr/NMCA battery cells) such as with the battery charger having the second lower output voltage, the switches control modules 264 may close the ones of the switches 256 that bypass the battery modules that include Gr/NMCA battery cells, open the switches 254 of the battery modules that include Gr/NMCA battery cells, open the ones of the switches 256 that bypass the battery modules that include Si/NMCA battery cells, close the switches 254 of the battery modules that include Si/NMCA battery cells.

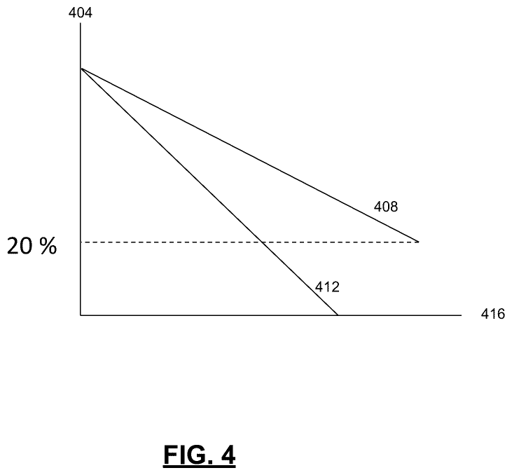

FIG. 4 includes an example graph of battery cell SOC 404 for Si/NMCA cells 408 and Gr/NMCA cells 412 over time 416. As illustrated, the switch control module 264 may actuate the switches such that the Gr/NMCA battery cells or battery modules including only Gr/NMCA battery cells discharge faster than the Si/NMCA battery cells or battery modules including only Si/NMCA battery cells. The switch control module 264 may also limit discharging of the Si/NMCA battery cells or battery modules including only Si/NMCA battery cells to a predetermined minimum SOC, such as 20 percent or another suitable minimum SOC.

The above provides a flexible battery (pack) architecture that combines the favorable features of two different types of battery cell chemistries. Faster charging can be achieved by the battery 199 including a greater amount of Si/NMCA battery cells. Longer range can also be achieved by the battery 199 including a greater amount of Si/NMCA battery cells. Longer cycling life can be achieved by the battery 199 including a greater amount of Gr/NMCA battery cells. A balance of battery characteristics can be achieved by including both types of battery cells.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A battery pack comprising:
first battery modules, the first battery modules each including first battery cells having a first battery cell chemistry and not including second battery cells having a second battery cell chemistry that is different than the first battery cell chemistry;
second battery modules, the second battery modules each including the second battery cells having the second battery cell chemistry and not including the first battery cells having the first battery chemistry;
switches; and
a switch control module configured to actuate the switches and control charging and discharging of the first and second battery modules.

2. The battery pack of claim 1, wherein the switches include:
first bypass switches configured to selectively connect and disconnect first inputs of the first battery modules with first outputs of the first battery modules, respectively; and
second bypass switches configured to selectively connect and disconnect second inputs of the second battery modules with second outputs of the second battery modules, respectively.

3. The battery pack of claim 1 wherein the first battery cell chemistry includes anodes including silicon and cathodes including nickel cobalt manganese aluminum (NMCA).

4. The battery pack of claim 3 wherein the anodes include at least 30 percent silicon.

5. The battery pack of claim 3 wherein the second battery cell chemistry includes anodes including graphite and cathodes including NMCA.

6. The battery pack of claim 5 wherein a percentage of a total number of the first and second battery cells of the battery pack that have the first battery cell chemistry is at least 20 percent and less than or equal to 80 percent.

7. The battery pack of claim 4 wherein the battery pack includes x percentage of the first battery cells and (1−x) percent of the second battery cells, wherein x is selected based on at least one of cycling lifetime, charging rate, discharging rate, and energy density.

8. The battery pack of claim 4 wherein the switch control module actuates ones of the switches to limit a depth of discharge of the first battery modules to a predetermined minimum state of charge.

9. The battery pack of claim 8 wherein the switch control module actuates other ones of the switches to discharge ones of the second battery modules to less than the predetermined minimum state of charge that is greater than zero state of charge.

10. The battery pack of claim 4 wherein the switch control module actuates ones of the switches to discharge the first battery modules at a first rate and discharge the second battery modules at a second rate that is greater than the first rate.

11. A battery pack comprising:
battery modules each including a plurality of battery cells;
wherein at least one of the battery modules includes first battery cells having a first battery cell chemistry and second battery cells having a second battery cell chemistry that is different than the first battery cell chemistry;
switches; and
a switch control module configured to actuate the switches and control charging and discharging of the battery modules and the battery cells.

12. The battery pack of claim 11, wherein the switches include first bypass switches configured to selectively connect and disconnect first inputs of the battery modules with outputs of the battery modules, respectively.

13. The battery pack of claim 11 wherein the first battery cell chemistry includes anodes including silicon and cathodes including nickel cobalt manganese aluminum (NMCA).

14. The battery pack of claim 13 wherein the anodes include at least 30 percent silicon.

15. The battery pack of claim 13 wherein the second battery cell chemistry includes anodes including graphite and cathodes including NMCA.

16. The battery pack of claim 15 wherein a percentage of a total number of the first and second battery cells of the battery pack that have the first battery cell chemistry is at least 20 percent and less than or equal to 80 percent.

17. The battery pack of claim 14 wherein the battery cells include x percentage of the first battery cells and (1−x) percent of the second battery cells, wherein x is selected based on at least one of cycling lifetime, charging rate, discharging rate, and energy density.

18. The battery pack of claim 14 wherein the switch control module actuates ones of the switches to limit a depth of discharge of the first battery cells to a predetermined minimum state of charge that is greater than zero state of charge.

19. The battery pack of claim 18 wherein the switch control module actuates other ones of the switches to discharge ones of the second battery cells to less than the predetermined minimum state of charge.

20. The battery pack of claim 14 wherein the switch control module actuates ones of the switches to discharge the first battery cells at a first rate and discharge the second battery cells at a second rate that is greater than the first rate.
